(19) United States
(12) Patent Application Publication
(10) Pub. No.: US 2005/0066957 A1
(43) Pub. Date: Mar. 31, 2005

(54) Barbecue cover assembly

(76) Inventor: Robert K. MacLean, Toronto (CA)

Correspondence Address: SMART AND BIGGAR, 438 UNIVERSITY AVENUE, SUITE 1500 BOX 111, TORONTO, ON, M5G2K8, CA

(21) Appl. No.: 10/951,708

(22) Filed: Sep. 29, 2004

Related U.S. Application Data
(60) Provisional application No. 60/506,153, filed on Sep. 29, 2003.

(51) Int. Cl. A47J 37/00

(52) U.S. Cl. 126/201; 126/42; 126/50; 126/41 R

(57) ABSTRACT

A cover assembly may be attached to a barbecue below the heating chamber of the barbecue. The assembly has a support to which one end of the cover is attached. In a collapsed configuration, the cover is stowed by the support. The cover may be drawn from the support to a deployed configuration covering the barbecue.

### CROSS-REFERENCE TO RELATED APPLICATION

This application claims priority from U.S. provisional application no. 60/506,153 filed Sep. 29, 2003.

### BACKGROUND

This invention relates to a cover assembly for a barbecue and to a barbecue having a cover assembly.

Outdoor barbecues are popularly used in warn weather. When not in use, especially during inclement or cold weather, the barbecue is often covered for protection. Typical barbecue covers are shaped to cover the top of the barbecue and drape down the sides when placed on the barbecue. When the cover is removed, it needs to be stored. Users have been known to throw the cover over a nearby chair or fence as temporary storage—which is clearly not ideal. Others may fold the cover and store the cover inside, however, this makes use of the cover inconvenient.

Therefore, there remains a need for a convenient and quick manner of covering a barbecue.

### SUMMARY OF INVENTION

A cover assembly may be attached to a barbecue below the heating chamber of the barbecue. The assembly has a support to which one end of the cover is attached. In a collapsed configuration, the cover is stowed by the support. The cover may be drawn from the support to a deployed configuration covering the barbecue.

Accordingly, the present invention comprises a barbecue cover assembly, comprising: a mount for mounting to a barbecue unit below a heating chamber of said barbecue unit; a support extending from said mount; a barbecue cover joined at one end to said support, said cover being collapsible for stowing by said support, said cover, when collapsed, being drawable from said support to a deployed configuration whereat said cover may cover said barbecue.

According to another aspect of the present invention, there is provided a barbecue comprising: a heating chamber; a downwardly extending heating chamber support; a cover support extending from said heating chamber support below said heating chamber; a barbecue cover joined at one end to said cover support; said cover support for stowing said barbecue cover.

### BRIEF DESCRIPTION OF THE DRAWINGS

In the figures which illustrate example embodiments of the invention,

FIG. 1A is rear perspective view of a barbecue fitted with a cover assembly of this invention illustrating the cover in a stowed configuration,

FIG. 1B is rear perspective view illustrating the cover partially deployed,

FIG. 2A is rear perspective view illustrating the cover filly deployed,

FIG. 2B is a magnified view of area marked 2B in FIG. 2A,

FIG. 3 is a perspective view of the cover assembly,

FIG. 4 is an exploded, partially broken away, view of the cover assembly, and

FIG. 5 is a perspective view of a cover assembly made in accordance with another embodiment of the invention.

### DETAILED DESCRIPTION

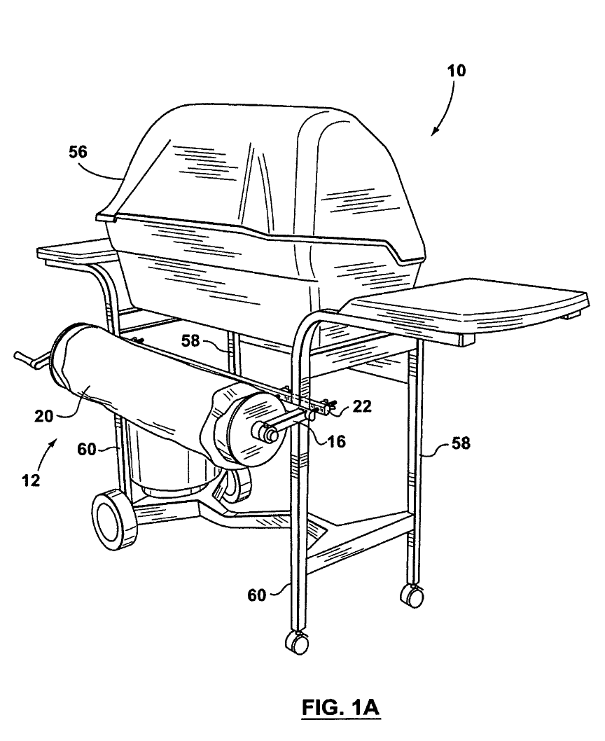

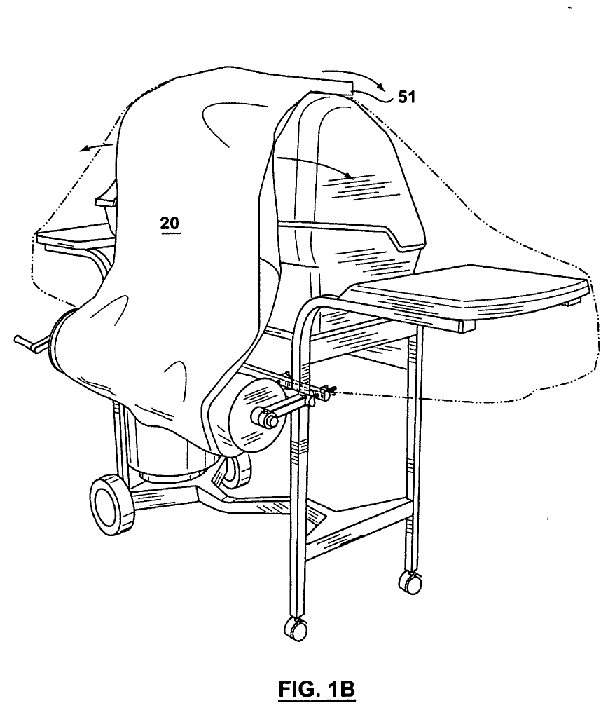

Turing to FIG. 1A, a barbecue unit 10 has cover assembly 12 made in accordance with this invention attached thereto. The cover assembly has a support 16 for supporting a barbecue cover 20 The support is joined to a barbecue mount 22.

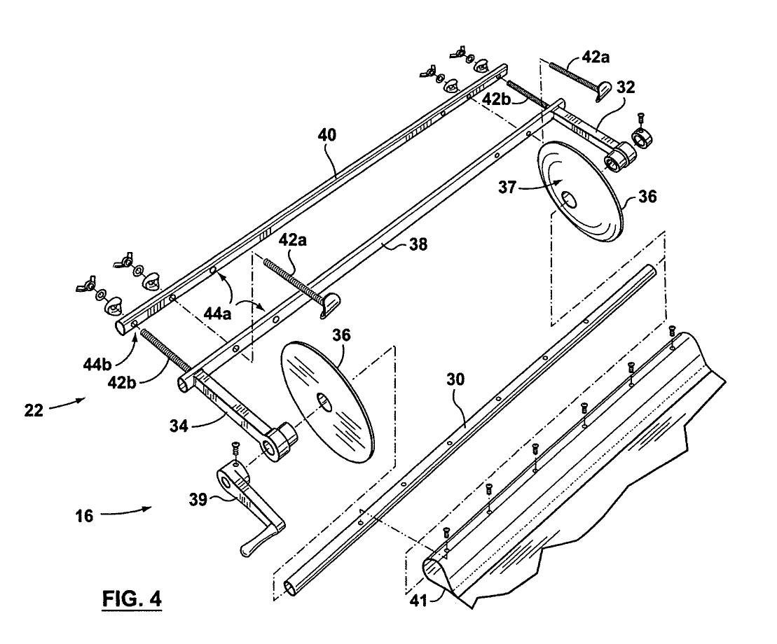

With reference to FIG. 4, the support comprises a roller 30 rotatably held between two arms 32, 34. A radially extending face plate 36 with an inwardly directed convex face 37 is positioned proximate each end of the roller. A handle 39 projects from one end of the roller. One end 41 of the barbecue cover 20 is joined to the roller 30. In the illustrative embodiment this is accomplished by the end 41 of the cover being looped around the roller and screws extending through the looped end of the cover into the roller, but of course this may also be accomplished in another manner.

The mount 22 comprises first and second bars 38, 40. The bars are held together by fasteners 42a, 42b. Fasteners 42b extend through holes 44b proximate the end of bar 40 while fasteners 42a extend through one of a series of aligned sets of through holes 44a in the bars. As illustrated each fastener 42a comprises a bolt and a nut and each fastener 42b comprises a threaded shaft welded to bar 38 and a nut. The arms 32, 34 of the support are joined to the first bar 38, as by welding.

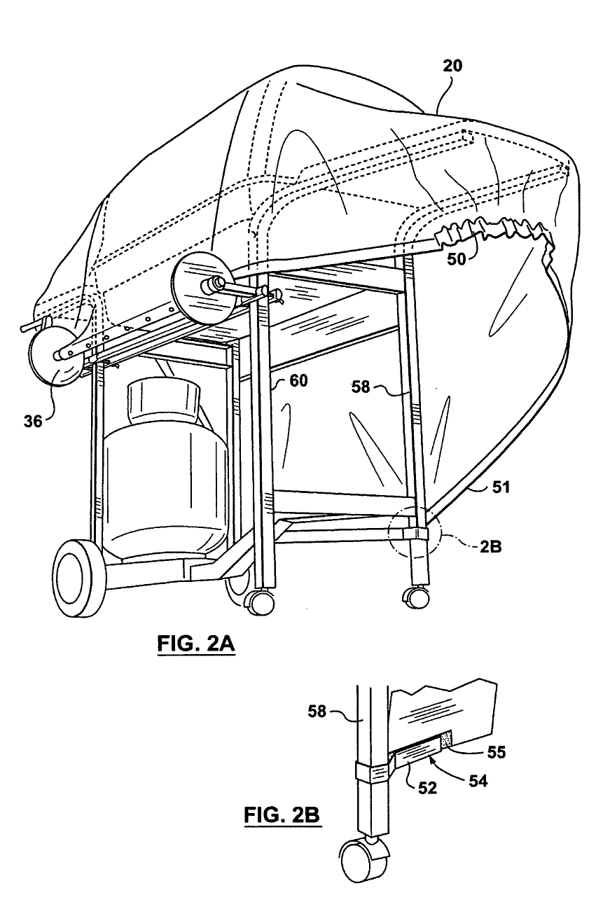

As seen in FIG. 2A, the barbecue cover 20 has sides 50 which are elastically gathered. Additionally, free end 51 of the cover 20 adjacent each side 50 has a strap 52 joined at one end to the cover and terminating in a fastener portion 54 which mates with another fastener portion 55 carried by the cover. These fastener portions may constitute a hook and loop fastener.

As is typical, barbecue 10 has a heating chamber 56 (such as a grill or cooker) supported by a pair of front legs 58 and a pair of rear legs 60.

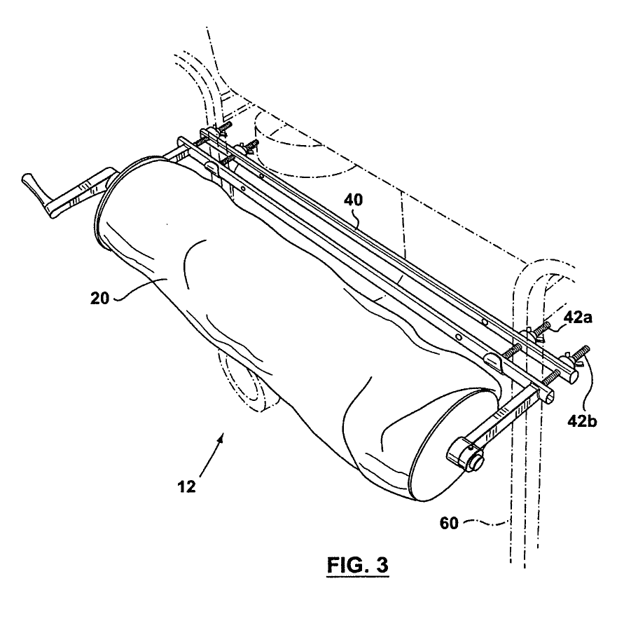

With reference to FIG. 3 and FIG. 4, to attach the cover assembly 12 to barbecue 10, the fasteners 42a, 42b are released and the second bar 40 removed. The first bar 38 may then be placed transversely of the outside of rear legs 60 of the barbecue with the fasteners 42b on the outside of the rear legs. If the fasteners 42a interfere with these legs, these fasteners may be removed and placed in other through holes 44a in bar 38 to the inside of the rear legs. Bar 40 is then placed on the inside of the rear legs 60 so that the fasteners extend through holes 44a, 44b of bar 40. The fasteners may then be fastened to clamp the two bars 38, 40 together, sandwiching the rear legs 60 of the barbecue between them.

After the cover assembly has been attached to the barbecue, in use, with the barbecue cover 20 in a collapsed configuration wound around roller 30 of support 16—as illustrated in FIG. 1A—a user may grab the free end 51 of the cover and draw it outwardly and upwardly, as illustrated in FIG. 1B. The roller 30 will rotate to allow this. Once the cover 20 has been unwound from the roller, the elastically gathered sides 50 allow the cover to stretch so that it may be deployed over the barbecue 20 as illustrated in FIG. 2A. The straps 52 may then be wrapped around the front legs 58 of the barbecue and the fastener portions 54, 55 mated, as illustrated in FIG. 2B.

To stow the deployed cover, the fastener portions 54 of the straps 52 are detached and the cover 20 pulled upwardly off the barbecue. As seen in FIG. 1B, sides 50 may then be folded over so that the cover has a generally rectangular shape. The handle 40 may then be rotated by the user to wind the cover onto the roller 30 of support 16. In this regard, the convex inwardly directed faces 37 of face plates 36 provide a larger distance between the plates at their periphery than at the roller. Thus, the plates act to progressively confine the portion of the folded cover which is radially closer to roller 30 as the folded cover is wound onto the roller 30.

It will be apparent from the foregoing that the cover, being always attached to the barbecue, is always at hand for use when needed. And further, that the cover may be stowed in an unobtrusive fashion.

Many modifications within the spirit of the invention are possible. For example, rather than a series of through holes 44b through the bars 38, 40, the bars may be provided with slots that allow the lateral positioning of the fasteners 42a to be varied. Further, optionally fasteners 42b may be identical in construction to fasteners 42a. Additionally, in some embodiments two fasteners, rather than four, may be sufficient to clamp bars 38, 40 together. Optionally, rather than the fasteners being in the nature of threaded shafts or bolts and nuts, the fasteners may be clamps, such as spring clamps. Further, rather than permitting the fasteners to be re-positioned on the bars, the bars themselves may be telescoping bars in order to permit the spacing of the fasteners to be adjusted to accommodate different rear leg spacing. However, in such instance, at least one of arms 32, 34 would be required to make a sliding connection with bar 38.

Optionally, barbecue 10 may be provided with openings in its rear legs 60 which accommodate fasteners 42b. In such circumstances, fasteners 42a and bar 40 are unnecessary as the fasteners 42b will attach bar 38 directly to the legs of the barbecue. In this regard, bar 38 may be also dispensed with and the threaded shaft of each fastener 42b affixed directly to the support arms 32, 34 of support 16. Alternatively, if fasteners 42b are constructed as bolts and nuts so that they can be removed from bar 38, a series of through holes 44a may be provided in bar 38 to allow the cover assembly 12 to be attached to different sized barbecues (i.e., barbecues with different rear leg spacings) by fastening fasteners 42b through the openings in the rear legs of the barbecue. Direct attachment to the rear legs, or other rear structure of the barbecue, is advantageous where the rear legs are inaccessible for clamping as may occur, for example, where the barbecue has doors under the heating chamber 56. As a liter alternative, the barbecue may be manufactured with an integral cover assembly. In this instance, the arms 32, 34 of the support may be directly attached, by welding or the like, to the rear of the barbecue.

As a further option, the fasteners may be strong magnets. In this instance, the magnets may clamp the bars 38, 40 together, or bar 40 (and optionally bar 38) may be omitted, and the magnets may fasten bar 38 (or support arms 32, 34) directly to the legs 60 of the barbecue.

The cover assembly should be positioned sufficiently below the heating chamber of the barbecue that heat from the heating chamber will not compromise the cover 20. Additionally, arms 32, 34 should be of sufficient length to space the cover from the bottom of the heating chamber so that hot droppings do not land on the cover.

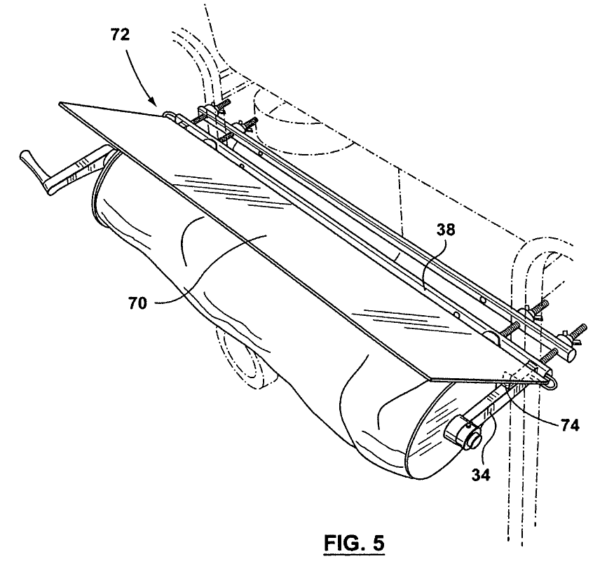

Alternatively, as illustrated in FIG. 5, a shroud may be provided. Turning to FIG. 5, shroud 70 may be hinged to bar 38 by pins 72 which extend in to the open ends of the bar. Stops 74 on the arms 32, 34 maintain the shroud in spaced relation to the cover 20. The shroud may be fabricated of sheet metal. With the shroud rotated to the limit allowed by stops 74, the cover is shielded from heat and droppings from the heating chamber. And during deployment of the cover, the shroud flips back out of the way.

Optionally, rather than, or in addition to, elastically gathering the sides 50 of the cover 20, the cover may be provided with one or more pairs of spaced male and female snap halves. Each pair of spaced male and female snap halves may be snapped closed to reduce the effective size of the cover. In this way, the cover may be adapted for use in covering a wider range of barbecue sizes. Of course the cover assembly 12 itself may be manufactured in a variety of sizes and/or with different cover configurations to accommodate different barbecues.

While the handle 39 is shown in FIG. 1A extending from the left side of the roller, it may optionally extend from the right side of the roller, which may better accommodate left handed users.

The support 16 has been illustrated as including a roller onto which the cover 20 is wound. Alternatively, the cover may be pleated with accordian folds and the support may include a platform to which one end of the pleated cover is attached. With this arrangement, the pleated cover may be collapsed onto the platform by accordian folding the cover and an elastic cord, or the like, extending from a side of the platform may be wound around the folded cover to maintain it in a stowed configuration. Again, the cover may be deployed by drawing the collapsed cover outwardly and upwardly from the support.

Other modifications will be apparent to those skilled in the art and, therefore, the invention is defined in the claims.

1. A barbecue cover assembly, comprising,
a mount for mounting to a barbecue unit below a heating chamber of said barbecue unfit;
a support extending from said mount;
a barbecue cover joined at one end to said support,
said cover being collapsible for stowing by said support, said cover, when collapsed, being drawable from said support to a deployed configuration whereat said cover may cover said barbecue.

2. The cover assembly of claim 1 wherein said support comprises a roller onto which said barbecue cover may be wound.

3. The cover assembly of claim 2 wherein said mount comprises a bar and at least two fasteners.

4. The cover assembly of claim 3 wherein said bar is a first bar and said mount further comprises a second bar, said at least two fasteners for joining said first bar to said second bar, said support being joined to said first bar.

5. The cover assembly of claim 3 wherein said bar has openings through which said at least two fasteners extend.

6. The cover assembly of claim 1 further comprising a shroud supported by one of said mount and said support.

7. The cover assembly of claim 6 wherein said shroud is hinged to said mount and further comprising stops for maintaining said shroud in spaced relation to the portion of said support to which said barbecue cover is attached.

8. The cover assembly of claim 2 further comprising a radially extending face plate proximate each end of said roller

9. The cover assembly of claim 8 wherein an inwardly directed face of each face plate is convex.

10. The cover assembly of claim 9 further comprising a handle extending from one end of said roller for rotating said roller.

11. The cover assembly of claim 3 wherein a second end of said barbecue cover opposite said one end has a pair of straps for securement to legs of a barbecue.

12. The cover assembly of claim 11 wherein each of said pair of straps terminates in a fastener portion and wherein said cover has a pair of complementary fastener portions.

13. The cover assembly of claim 12 wherein opposite sides of said barbecue cover are elastically gathered.

14. The cover assembly of claim 3 wherein said support further comprises a pair of arms rotatably supporting said roller at one end and joined to said bar at an opposite end.

15. A barbecue comprising:
a beating chamber;
a downwardly extending heating chamber support;
a cover support extending from said heating chamber support below said heating chamber;
a barbecue cover joined at one end to said cover support;
said cover support for stowing said barbecue cover.

16. The barbecue of claim 15 wherein said cover support comprises a roller onto which said barbecue cover may be wound

17. The barbecue of claim 16 wherein said heating chamber support comprises a pair of rear legs to which said cover support is mounted and further comprises a pair of front legs and wherein a second end of said barbecue cover opposite said one end has a pair of straps for securement to respective ones of said pair of front legs when said barbecue cover is deployed.

18. The barbecue of claim 17 wherein opposite sides of said barbecue cover are elastically gathered.

19. The barbecue of claim 18 further comprising a radially extending face plate proximate each end of said roller and wherein an inwardly directed face of each face plate is convex.

20. The barbecue of claim 15 further comprising a shroud hinged to one of said mount and said cover support having a shrouding position overlaying said cover support for shrouding said cover when stowed on said cover support.
